(19) United States
(12) Patent Application Publication
(10) Pub. No.: US 2020/0126438 A1
(43) Pub. Date: Apr. 23, 2020

(54) SYSTEM AND METHODS FOR AUTOMATED INTERACTIVE LEARNING

(71) Applicant: SOACH INC., Toronto (CA)

(72) Inventors: Shady SHEHATA, Waterloo (CA); Chahid OUALI, Kitchener (CA); Fakhri KARRAY, Waterloo (CA)

(73) Assignee: SOACH INC., Toronto (CA)

(21) Appl. No.: 16/657,131

(22) Filed: Oct. 18, 2019

Related U.S. Application Data
(60) Provisional application No. 62/747,612, filed on Oct. 18, 2018.

(51) Int. Cl. G09B 5/14; G06F 16/901; G06Q 10/06; G06Q 50/20; G06N 3/02

(52) U.S. Cl. CPC G09B 5/14; G06F 16/901; G06N 3/02; G06Q 50/20; G06Q 10/063112

(57) ABSTRACT

The present invention relates to a system and methods for automated interactive learning providing an interactive learning system for one or more users. The users of the learning system and methods may be students, trainees, or any user that generates queries and/or questions to the system. In one embodiment, the system and methods for automated interactive learning comprises a semantic routing model, a deep learning model, an automated student learning needs model, a helping service model, a content priori knowledge service model, a computer implemented system, and mobile objects. The semantic routing model provides routing of user queries to one or more tutors. The one or more tutors may have knowledge necessary to answer the user queries. If not, the semantic routing model directs the user query to a tutor possessing knowledge sufficient to adequately provide an accurate answer to the query. The semantic routing model also provides real-time interaction with users to the selected tutor.

### CROSS-REFERENCE TO RELATED APPLICATIONS—CLAIM OF PRIORITY

This patent application claims the benefit of priority under 35 U.S.C. § 119 (e) to U.S. Provisional Application No. 62/747,612 filed Oct. 18, 2018 entitled “System and Methods for Automated Interactive Learning”, the contents of which are incorporated herein by reference as if set forth in full.

### FIELD OF THE INVENTION

The present invention relates to a computerized training and learning system. More particularly the present invention relates to a system and methods for automated interactive learning.

### BACKGROUND OF THE INVENTION

The prior art is replete with computerized or computer implemented training systems. Training systems typically include methods involving training related queries and answer generation. Training takes place in a virtual environment created by a programmed computer system. Known training systems provide trainees with classroom lessons and computer-based training (CBT) typically delivered by a computer or by a human instructor. This is typically followed by an after-action review that is provided trainees from which the effectiveness of training on the trainees can be judged and determined. If an assessment is not determined to be positive for a trainee (having been effectively trained by the course of instruction), the computer system either repeats the instruction process for the trainee, or it initiates a remedial process to bring the trainee up to an effective level of understanding. This, a rigid sequential process is repeated for all trainees who follow the identical sequence of instruction until the assessment indicates an adequate effectiveness of the training provided by such systems.

Intelligent tutoring systems are currently being developed. A major advantage of these systems (and also relevant to this work) is that the tutoring systems can create a worked-out solution with detailed explanations for any problem entered by a student or a teacher from any type of source, whether it be a textbook, a software program, or any randomly entered external problem.

A number of different types of devices and methods for tutoring and interaction of students and tutors are exemplified in the prior art. For example, prior art document U.S. Pat. No. 6,606,479B2 discloses a system and method for interactive, adaptive, and individualized computer-assisted instruction. The described invention includes an agent for each student which adapts to each student, and provides individualized guidance to each student and provides controls to the augmented computer assisted instructional materials. The instructional materials of the described invention are augmented to communicate a student's performance and the material's pedagogical characteristics to an agent, and to receive control from an agent. In a preferred embodiment, the agent maintains data reflecting the student's pedagogic or cognitive characteristics in a protected and portable media in the personal control of the student. Preferably, the content of the communication between the agent and the materials conforms to specified interface standards so that the agent acts independently of the content of the particular materials. Also preferably, the agent can project using various I/O modalities and integrated engaging lifelike displays resembling a real person.

Another prior art example is described in EP2087233 which discloses a system of computers on a wide area network that establishes connections between nodes on the basis of their multidimensional similarity at a particular point in time in a certain setting, such as a social learning network, and that sends relevant information to the nodes. Dimensions in the definition of similarity include a plurality of attributes in time and community space. Examples of such dimensions and attributes may include a position in a learning community's project cycle, titles of readings and projects, genre or subject matter under consideration, age, grade, or skill level of the participants, and language. Each of the network's nodes is represented as a vector of attributes and is searched efficiently and adaptively through a variety of multidimensional data structures and mechanisms. The system includes synchronization that can transform a participant's time attributes on the network and coordinate the activities and information of each participant.

U.S. Pat. No. 9,786,193B2 discloses a system and method for training a student employing a simulation station that displays output to the student and receives input from the student. The computer system includes a rules engine operating thereon and computer accessible data storage storing learning object data including learning objects configured to provide interaction with the student at the simulation system. The system further includes rule data defining a plurality of rules accessed by the rules engine. The rules data includes, for each rule, respective “if-portion” data defining a condition of data and “then-portion” data defining an action to be performed by the simulation station. The rules engine causes the computer system to perform the action when the condition of data is present in the data storage. For at least some of the rules, the action comprises outputting one of the learning objects so as to interact with the student. The system may be networked with middleware and adapters that map data received over the network to a rules engine memory.

US20090286218A1 discloses a computer for grading student work on a problem when a student's steps are shown in detail. A reference trace is created representing a best solution path to the problem. A student trace of the student's work is then created, which involves explicitly searching for a specific rationale for appending a step to the student trace; deeming the step a correct production provided the step was able to be reproduced and marking the step as traced; provisionally accepting the step as part of a best solution path subject to update and revocation if a better quality step is later found by a step conflict check; implicitly tracing the student's work to determine implicitly taken mental steps provided the explicit tracing failed to justify the step; appending any remaining untraced steps to the student trace and excluding them from the best solution path; computing a value of the steps in the student's work to produce a student value; and, comparing the student value to a total value of the steps in the reference trace to obtain a score.

US20090286218A1 discloses a system that provides a goal-based learning system utilizing a rule-based expert training system to provide a cognitive educational experience. The system provides the user with a simulated environment that presents a business opportunity to understand and solve optimally. Mistakes are noted and remedial educational material presented dynamically to build the necessary skills that a user requires for success in a business endeavor. The system utilizes an artificial intelligence engine driving individualized and dynamic feedback with synchronized video and graphics used to simulate real-world environments and real-world interactions. Multiple “correct” answers are integrated into the learning system to allow individualized learning experiences in which navigation through the system is at a pace controlled by a learner. A robust business model provides support for realistic activities and allows a user to experience real-world consequences for their actions and decisions and entails real-time decision making and synthesis of the educational material. A dynamic feedback system is utilized that narrowly tailors feedback and focuses it based on the performance and characteristics of the student to assist the student in reaching a predefined goal.

The above described references and many other similar references have one or more of the following shortcomings: (a) the costs associated with these systems are high; (b) the tools used by the know systems are complex; (c) the Query-response mechanisms are not in real-time; (d) they systems do not provide human behavioral artificial tutors, that is, tutors that approximately mimic human beings. The previous solutions can be perceived to be sophisticated and extremely difficult to implement because of the complexity of the overall training system.

The present disclosure is related to use of systems and methods for automated interactive learning which provides an advanced training system for new generations of students.

### SUMMARY OF THE INVENTION

The present invention relates to systems and methods for automated interactive learning which is used for providing an interactive learning system for use by a user. The user may be a student, trainee, or anyone generating a query and/or question.

One aspect of the present invention is to provide a system and methods for automated interactive learning comprising a semantic routing model, a deep learning model (content dependent and content independent), an automated student learning needs model, a helping service model, a content priori knowledge service, a computer implemented system, and mobile objects.

Another aspect of the present invention is to provide a semantic routing model. The semantic routing model routes a user's query or queries to one or a plurality of tutors. A selected tutor may have knowledge sufficient to answer the user's query. Otherwise the semantic routing model directs the user query to a tutor having knowledge necessary to provide a solution responsive to the user's query. The semantic routing model also provides real-time interaction with the user from the tutor optionally within a fixed period/amount of time.

Yet another aspect of the present invention is to provide a deep learning model which is further comprised of a content independent conversational model and a content dependent conversational model. The content dependent conversational model is also optionally referred to herein as a content dependent question solution model. The content independent conversational model includes tutor and student dialogue annotations and tutor and student Quality analysis annotations. The content dependent conversational model includes course contents and problem-solving step annotations. The course contents includes all the material that a user or students may submit queries about.

Another aspect of the present invention is to provide an automated student learning needs model. The automated student learning needs model is also referred to herein as an interactive based conversational model. In this model, a computer implemented system mimics and/or repeats human knowledge and their intricate level of interaction to or with the user. The automated student learning model is comprised of the following steps:

i. Receiving an incoming query from a user;

ii. Directing the query of step i. to a tutor for an accurate answer and to receive human behavioral knowledge in solving the query;

iii. Finding gaps and or lapses in user understanding and providing missing information or clarifying misconceptions the user has; and

iv. Providing the same answer and behavioral experience to the user for a next same type of query.

Yet another aspect of the present invention is to provide a helping service model. The helping service model assists the user in finding an accurate solution or answer to the user's query. The helping service model is further comprised of a solution engine executer, a next topic recommender, an incoming question topic identifier, a solution methods identifier and an optionally a question topic matcher. The solution engine executer provides service that enables solving the problem raised by the user's query by executing steps that are displayed or performed in the computer implemented system. The inventive system includes a GUI (graphical user interface) that allows the user to access the computer implemented system using mobile objects. The mobile objects may, without limitation, include the following: wireless phones, laptops, PCs, smartphones, wired (i.e., so-called landline telephones), and other devices that are used to communicate from one location to another location. The next topic recommender recommends the next topic after identifying the topic presented by a query. The incoming question topic identifier identifies the topic of the question in order to match this topic with the topics presented in the hierarchy of topics in the future. The solution method identifier identifies the method/theorem that should be used in order to solve the question. This method is part of the solution. For example: “Shell Method is used to find the volume of solids of revolutions”.

Another aspect of the present invention is to provide a content priori knowledge service model. The content priori knowledge service model consists of a content taxonomy creator which converts the course content with background knowledge into a hierarchy of topics that shows dependencies among these topics. For example: in order for a user to learn topic x, the user must also learn topics y and z and the topics ontology which is created from the course content (e.g., books) and information documented by tutors about the dependencies between course topics. It also has information about the details of each topic in the content and the solution steps of these topics. The ontology can also be used for applying inference to find knowledge that has not been explicitly mentioned. The taxonomy creator is also referred to herein as topic dependencies and the topic ontology consists of topic content details and a database predefined solution.

Before describing at least one embodiment of the invention in detail, it is to be understood that the invention is not limited in its application to the details of construction and to the arrangements of the components set forth in the following description or as illustrated in the drawings. The invention is capable of other embodiments and of being practiced and carried out in various ways. Also, it is to be understood that the phraseology and terminology employed herein are for the purpose of description only and should not be construed as limiting.

These together with other objects of the invention, along with the various features of novelty which characterize the invention, are pointed out with particularity in the present disclosure. For a better understanding of the claimed invention, its operating advantages and the specific objects attained by its uses, reference should be had to the accompanying drawings and descriptive matter in which there are illustrated embodiments of the invention.

The details of one or more embodiments of the invention are set forth in the accompanying drawings and the description below. Other features, objects, and advantages of the invention will be apparent from the description and drawings, and from the claims.

### BRIEF DESCRIPTION OF THE DRAWINGS

FIG. 1 is a schematic diagram of a system and methods for automated interactive learning in accordance with the present invention.

FIG. 2 is a schematic diagram of a deep learning model in accordance with the present invention.

FIG. 3 is a schematic diagram of an automated student learning needs model in accordance with the present invention.

FIG. 4 is a schematic diagram of a semantic routing model in accordance with the present invention.

Like reference numbers and designations in the various drawings indicate like elements.

### DETAILED DESCRIPTION OF THE INVENTION

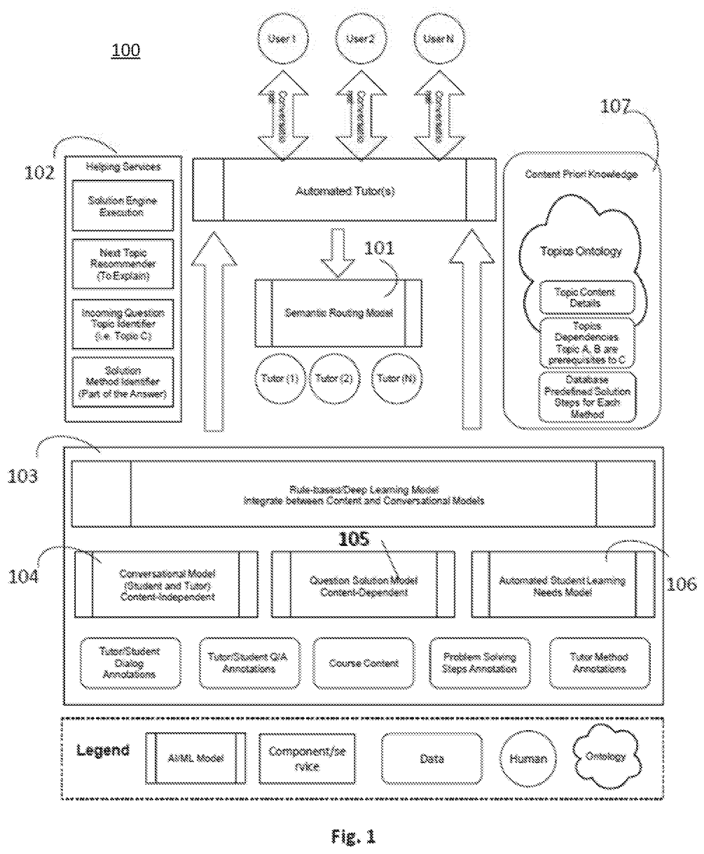

FIG. 1 is a schematic diagram of a system and methods for automated interactive learning in accordance with the present invention. The automated interactive learning 100 is used for providing an interactive learning system for use by a user. The user may be a student, trainee, or anyone that generates a query and/or question to the learning system. In one embodiment, the present system and methods for automated interactive learning 100 comprises a semantic routing model 101, a deep learning model 103, an automated student learning needs model 106, a helping service model 102, a content priori knowledge service model 107, a computer implemented system, and mobile objects. The semantic routing model 101 routes queries input by a user to one or a plurality tutors. The plurality of tutors may have knowledge of the query of the user, otherwise the semantic routing model 101 directs the user query to a tutor who has knowledge of the user query. The semantic routing model 101 also provides real-time interaction with the user to the tutor optionally within a fixed period/amount of time.

The system and methods for automated interactive learning 100 are comprised of the following steps:

i. Receiving a query from the user;

ii. Identification of topics of the step (i) query using the content priori knowledge service model 103;

iii. Identification of the prerequisite topics from the content Ontology of the topics of the query of step (ii). It also identifies the method and the solution of the question using the content priori knowledge service model 103;

iv. Recommendation of extra background on the same topic question to the user by the computer implemented system using the helping service model 102;

v. Finding the solution of the query of the user using deep learning model 103;

vi. Providing content knowledge based and conversational based dialogue to the user in response of the query using automated student learning model; and

vii. Approaching to a human tutor at any point of time in the response to the query of the user using semantic routing model 101.

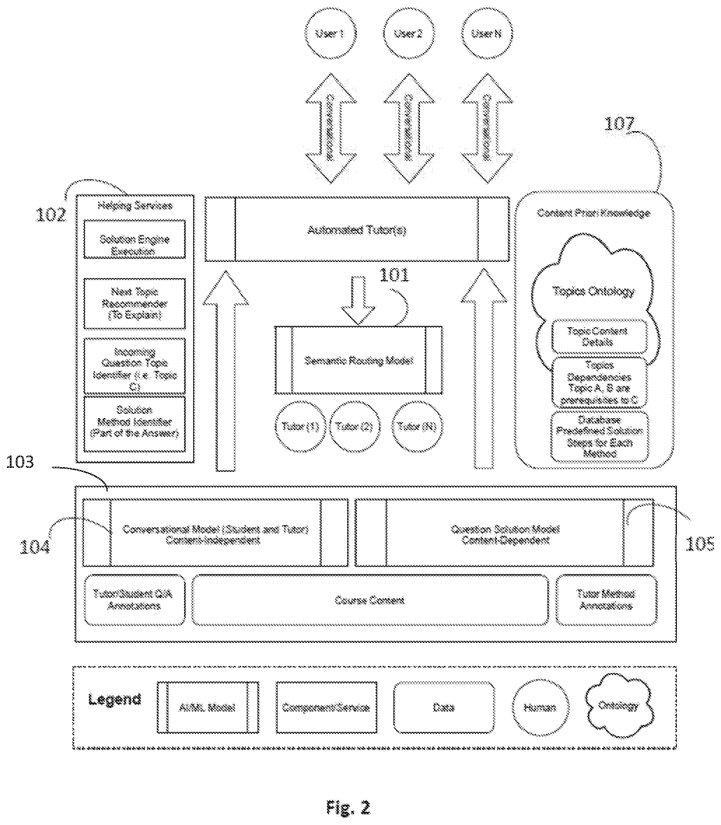

Yet another embodiment of the present invention includes a deep learning model 103. FIG. 2 depicts a schematic diagram of a deep learning model 103 of the present invention. The deep learning model 103 comprises (a) a content independent conversational model 104 and (b) a content dependent conversational model 105. The content dependent conversational model 105 is also referred to herein as a content dependent question solution model. The content independent conversational model 104 includes tutor and student dialogue annotations and tutor and student Quality analysis annotations. The content dependent conversational model 105 includes course contents and problem-solving step annotations. The course contents include all of the material that a user or student can query about.

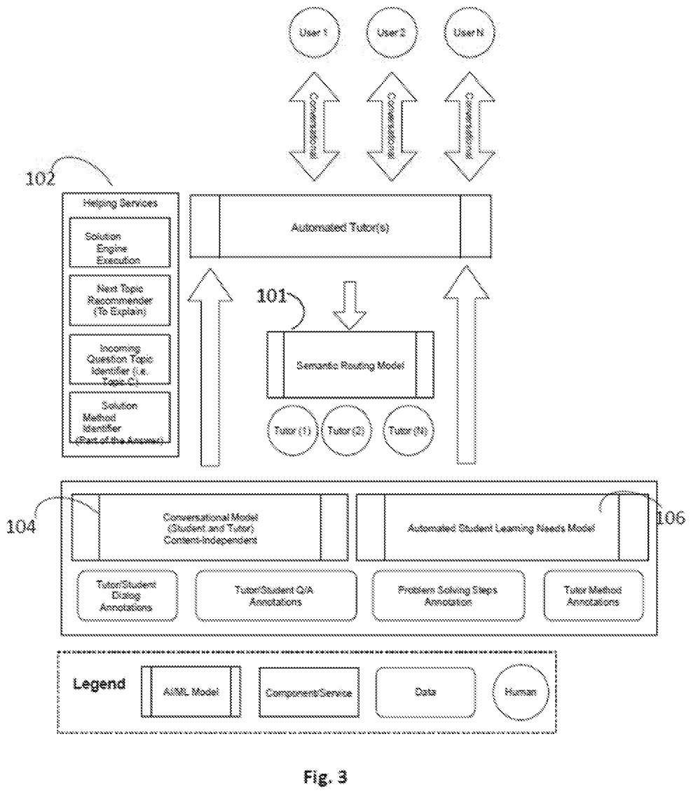

Another embodiment of the present invention includes an automated student learning needs model 106. FIG. 3 depicts a schematic diagram of an automated student learning needs model 106. The automated student learning model is also referred herein as an interactive based conversational model. In this embodiment, the computer implemented system mimics and/or repeats the human knowledge and their intricate level of interaction with the user. The automated student learning model comprises of the following steps:

i. Receiving a query from a user;

ii. Directing the query of step (i) to the tutor for an accurate answer and to receive human behavioral knowledge in solving the query;

iii. Finding gaps and/or lapse in user understanding and providing the missing information or clarifying misconceptions the user has; and

iv. Providing the same answer and behavioral experience to the user for the next same type of query.

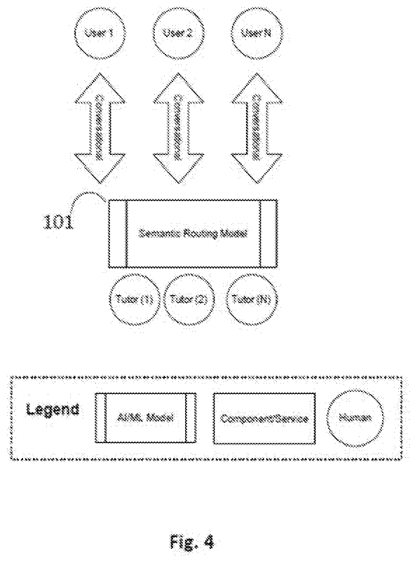

FIG. 4 shows a schematic diagram of a semantic routing model. The semantic routing model 101 routes a user's query to a tutor or to a plurality of tutors. The plurality of tutors may have knowledge to answer the user's query. If not, the semantic routing model 101 directs the user query to those tutors who have knowledge of the user query. The semantic routing model 101 also provides real-time interaction with the user to the tutor optionally within the fixed period/amount of time.

Yet another embodiment of the present invention is to provide a helping service model 102. The helping service model 102 assists the user in finding an accurate solution to the query. The helping service model 102 is further comprised of a solution engine executer, a next topic recommender, an incoming question topic identifier, a solution methods identifier and optionally a question topic matcher. The solution engine executer provides service that enables the system to solve the problem posed by the query by executing the steps that are displayed or performed in the computer implemented system. A GUI (graphical user interface) allows the user to access the computer implemented system in the mobile objects. The mobile objects can include a mobile phone, a laptop, a PC, a smartphone, a telephone, and other devices that are used to communicate information or data from one location to another location. The next topic recommender recommends the next topic after identifying the topic of the question. The incoming question topic identifier identifies the topic of the question in order to match this topic with the topics presented in the hierarchy of topics in the future. The solution method identifier identifies the method/theorem that should be used in order to solve the query. This method is part of the solution. For example: “Shell Method is used to find the volume of solids of revolutions.”

Another embodiment of the present invention is to provide a content priori knowledge service model 107 as shown in FIGS. 1 and 2. The content priori knowledge service model 107 consists of a content taxonomy creator which converts the course content with background knowledge into a hierarchy of topics that shows dependencies among these topics. For example: in order to learn topic x, a user must learn topics y and z and the topics ontology which creates from the course content (e.g., books) and information documented by tutors about the dependencies between course topics. It also has information about the details of each topic in the content and the solution steps of these topics. The ontology can also be used for applying inference to find knowledge that has not been explicitly mentioned. The taxonomy creator may also be referred to herein as topic dependencies and the topic ontology consists of topic content details and the database predefined solution.

Another embodiment of the present invention provides a data collection and an annotation model. The data collection and annotation model captures human intelligence in a structured format in order for the system to achieve deep learning from humans in order to behave the same way that humans behave when solving problems and in the conversational interactions with the user/learner. The data collection and annotation model is comprised of a human data collection model and a content base data collection model. The human data collection model captures human behavior while solving a query received from the user. The content base data collection model identifies incoming questions and/or incoming queries from the user in multiple topics and identifies the method/theorem that should be used to solve the question/query, specific content data needs to be captured and segmented. This collection method allows subject matter experts to tag content data based different levels, such as question level, pre-content level and content level. The question level is used to specify methods/theorems that the computer implemented system used to solve the problem. The pre-content level is used to specify prerequisite topics they believe are relevant to solve the problem and the content level is used to specify the steps executed to solve the problem.

It is to be understood that the above description is intended to be illustrative, and not restrictive. For example, the above-discussed embodiments may be used in combination with each other. Many other embodiments will be apparent to those of skill in the art upon reviewing the above description.

The benefits and advantages which may be provided by the present invention have been described above with regard to specific embodiments. These benefits and advantages, and any elements or limitations that may cause them to occur or to become more pronounced are not to be construed as critical, required, or essential features of any or all of the embodiments.

While the present invention has been described with reference to particular embodiments, it should be understood that the embodiments are illustrative and that the scope of the invention is not limited to these embodiments. Many variations, modifications, additions and improvements to the embodiments described above are possible. It is contemplated that these variations, modifications, additions and improvements fall within the scope of the invention.

### CONCLUSION

A number of embodiments of the invention have been described. It is to be understood that various modifications may be made without departing from the spirit and scope of the invention. For example, some of the steps described above may be order independent, and thus can be performed in an order different from that described. Further, some of the steps described above may be optional. Various activities described with respect to the methods identified above can be executed in repetitive, serial, or parallel fashion.

It is to be understood that the foregoing description is intended to illustrate and not to limit the scope of the invention, which is defined by the scope of the following claims, and that other embodiments are within the scope of the claims. In particular, the scope of the invention includes any and all feasible combinations of one or more of the processes, machines, manufactures, or compositions of matter set forth in the claims below. (Note that the parenthetical labels for claim elements are for ease of referring to such elements, and do not in themselves indicate a particular required ordering or enumeration of elements; further, such labels may be reused in dependent claims as references to additional elements without being regarded as starting a conflicting labeling sequence).

What is claimed is:

1. An automated interactive learning system for use by one or more users generating queries to one or more tutors, comprising:
(a) a semantic routing model, wherein the semantic routing model routes a selected query input by the one or more users to the one or more tutors;
(b) a deep learning model, comprising:
(1) a content independent conversational model; and
(2) a content dependent conversational model;
(c) an automated student learning needs model, wherein the learning needs model interacts with the one or more users in a manner that mimics human behavior;
(d) a helping service model that assists the one or more users in finding accurate solutions or answers to the selected query;
(e) a content priori knowledge service model, comprising a content taxonomy creator that converts course content having background knowledge information into a hierarchy of topics, wherein the hierarchy of topics shows dependencies among the topics; and
(f) one or more mobile objects that communicate information and data from a first location to a second location.

2. The automated interactive learning system of claim 1, wherein the student learning needs model is further configured to:
(a) receive the selected query from the one or more users;
(b) direct the selected query received in step (a) to a selected tutor in order to obtain an accurate answer to the selected query and to determine human behavioral knowledge necessary to solve the selected query;
(c) identify lapses in understanding of the one or more users and either provide missing information to the one or more users or clarify misconceptions of the one or more users if misconceptions are determined to be present; and
(d) provide answers that are similar or identical to the accurate answer obtained in step (b) whenever additional queries are input that are similar or identical to the selected query.

3. The automated interactive learning system of claim 1, wherein the semantic routing model determines which tutor to route the selected query to, and wherein this determination is dependent upon which tutor has knowledge sufficient to accurately answer the selected query.

4. The automated interactive learning system of claim 3, wherein the semantic routing model provides real-time interactions between the one or more users and the one or more tutors.

5. The automated interactive learning system of claim 1, wherein the content independent conversational model includes tutor and user dialogue annotations and tutor and user Quality analysis annotations.

6. The automated interactive learning system of claim 1, wherein the content dependent conversational model includes course contents and problem solving step annotations, and wherein the course contents include all of the material that users may query about.

7. The automated interactive learning system of claim 1, wherein the helping service model comprises:
(a) a solution engine executer, wherein the solution engine executer enables the automated learning system to produce the accurate answer to the selected query;
(b) a next topic recommender, wherein the next topic recommender recommends a next topic after identifying a topic raised by the selected query;
(c) an incoming question topic identifier, wherein the incoming question topic identifier identifies the topic raised by the selected query;
(d) a solution methods identifier, wherein the solution methods identifier identifies a method or theorem used to produce the accurate answer to the selected query; and
(e) a question topic matcher.

8. The automated interactive learning system of claim 1, wherein the one or more mobile objects may comprise one or more of the following: wireless phones, laptops, PCs, smartphones, wired (i.e., so-called landline telephones), and any other devices that communicate information or data from one location to another location.

9. The automated interactive learning system of claim 1, further comprising a Graphical User Interface (GUI) that allows the one or more users to interact with the learning system.

10. A method of automated interactive learning, including:
(a) receiving a selected query from one or more users;
(b) directing the selected query received in step (a) to a selected tutor in order to obtain an accurate answer to the selected query and also to determine human behavioral knowledge necessary to provide the accurate answer to the selected query;
(c) identifying lapses in understanding of the one or more users and either:
(1) providing missing information to the one or more users, or
(2) determining if the one or more users have misconceptions related to the selected query, and if so, clarifying the misconceptions to the one or more users; and
(d) providing answers that are similar or identical to the accurate answer obtained in step (b) whenever additional queries are received that are similar or identical to the selected query received in step (a).

11. An automated interactive learning system for use by one or more users inputting queries to one or more tutors, comprising:
(a) a semantic routing model means, wherein the semantic routing model means routes a selected query input by the one or more users to the one or more tutors;
(b) a deep learning model means, comprising:
(1) a content independent conversational model; and
(2) a content dependent conversational model;
(c) an automated student learning needs model means, wherein the learning needs model means interacts with the one or more users in a manner that mimics human behavior;
(d) a helping service model means that assists the one or more users in finding accurate solutions or answers to the selected query;
(e) a content priori knowledge service model means, wherein the content priori knowledge service model means comprises a content taxonomy creator that converts course content having background knowledge information into a hierarchy of topics, and wherein the hierarchy of topics shows dependencies among the topics; and
(f) one or more mobile objects means that communicate information from a first location to a second location.

12. The automated interactive learning system of claim 11, wherein the semantic routing model means determines which tutor to route the selected query to, and wherein this determination is dependent upon which tutor has knowledge sufficient to accurately answer the selected query.

13. The automated interactive learning system of claim 12, wherein the semantic routing model means provides real-time interactions between the one or more users and the one or more tutors.

14. The automated interactive learning system of claim 11, wherein the content independent conversational model includes tutor and user dialogue annotations and tutor and user Quality analysis annotations.

15. The automated interactive learning system of claim 11, wherein the content dependent conversational model includes course contents and problem solving step annotations, and wherein the course contents include all of the material that users may make queries about.

16. The automated interactive learning system of claim 11, wherein the helping service model means comprises:
(a) a solution engine executer, wherein the solution engine executer enables the automated learning system to produce the accurate answer to the selected query;
(b) a next topic recommender, wherein the next topic recommender recommends a next topic after identifying a topic raised by the selected query;
(c) an incoming question topic identifier, wherein the incoming question topic identifier identifies the topic raised by the selected query;
(d) a solution methods identifier, wherein the solution methods identifier identifies a method or theorem used to produce the accurate answer to the selected query; and
(e) a question topic matcher.

17. The automated interactive learning system of claim 11, wherein the one or more mobile objects means may comprise one or more of the following: wireless phones, laptops, PCs, smartphones, wired (i.e., so-called landline telephones), and any other devices that communicate information or data from one location to another location.

18. The automated interactive learning system of claim 11, further comprising a Graphical User Interface (GUI) means that allows the one or more users to interact with the learning system.

19. The automated interactive learning system of claim 1, further comprising a data collection and annotation model, wherein the data collection and annotation model captures human intelligence in a structured format enabling the learning system to achieve enhanced learning capabilities from humans.

20. The automated interactive learning system of claim 19, wherein the system emulates human behavior in a manner that humans exhibit when solving problems, and wherein the system uses conversational interactions with the one or more users.
